(19) United States
(12) Patent Application Publication
(10) Pub. No.: US 2025/0353523 A1
(43) Pub. Date: Nov. 20, 2025

(54) APPARATUS FOR CONTROLLING VEHICLE AND METHOD THEREOF

(71) Applicants: Hyundai Motor Company, Seoul (KR); Kia Corporation, Seoul (KR)

(72) Inventor: Sang Min Sim, Hwaseong-Si (KR)

(21) Appl. No.: 18/931,663

(22) Filed: Oct. 30, 2024

(30) Foreign Application Priority Data
May 17, 2024 (KR) 10-2024-0064598

(51) Int. Cl. B60W 60/00; B60W 30/09; G06F 17/18

(52) U.S. Cl. CPC B60W 60/001; B60W 30/09; G06F 17/18; B60W 2554/20; B60W 2554/4041

(57) ABSTRACT

An apparatus for controlling autonomous driving of a vehicle is introduced. The apparatus may comprise a first sensor configured to obtain first sensor data, a second sensor configured to obtain second sensor data, a third sensor configured to obtain third sensor data, and a processor configured to generate a probability distribution map by dividing an area into a plurality of cells, wherein the area may comprise a designated angle in a designated direction from the vehicle, obtain, based on the probability distribution map, a first probability distribution for the first sensor data and a second probability distribution for the second sensor data, and control the autonomous driving of the vehicle by determining, based on fusing the first probability distribution, the second probability distribution, and the third sensor data, at least one of a static obstacle or a dynamic obstacle.

### CROSS-REFERENCE TO RELATED APPLICATION

This application claims the benefit of priority to Korean Patent Application No. 10-2024-0064598, filed in the Korean Intellectual Property Office on May 17, 2024, the entire contents of which are incorporated herein by reference.

### TECHNICAL FIELD

The present disclosure relates to a vehicle control apparatus and a method thereof, and more particularly, relate to a technology for fusing sensor data.

### BACKGROUND

The matters described in this Background section are only for enhancement of understanding of the background of the disclosure, and should not be taken as acknowledgement that they correspond to prior art already known to those skilled in the art.

A driving assistance mode or an autonomous driving mode of a vehicle is rapidly developing. If the driving assistance mode or autonomous driving mode of the vehicle is executed, a technology for obtaining various pieces of sensor data by using various sensors (e.g., a camera, a RADAR, and/or a LiDAR), and controlling the vehicle by using the obtained sensor data is being developed.

Each of the sensors includes its own advantages and disadvantages. Various research efforts are underway to offset the disadvantages and emphasize the advantages. In particular, if an external object is detected by fusing pieces of sensor data, because it is determined to detect different objects from each other even though the same object is detected, the reliability of the detected object may not be guaranteed. Accordingly, various studies are being conducted to solve the issues.

### SUMMARY

According to the present disclosure, an apparatus for controlling autonomous driving of a vehicle, the apparatus may comprise a first sensor configured to obtain first sensor data, a second sensor configured to obtain second sensor data, a third sensor configured to obtain third sensor data, and a processor configured to generate a probability distribution map by dividing an area into a plurality of cells, wherein the area may comprise a designated angle in a designated direction from the vehicle, obtain, based on the probability distribution map, a first probability distribution for the first sensor data and a second probability distribution for the second sensor data, and control the autonomous driving of the vehicle by determining, based on fusing the first probability distribution, the second probability distribution, and the third sensor data, at least one of a static obstacle or a dynamic obstacle.

The apparatus, wherein the processor is configured to obtain a first candidate virtual box based on an update age of the third sensor data being greater than or equal to a first threshold value and at least one of a length of a virtual box obtained from the third sensor data or a width of the virtual box being greater than or equal to a second threshold value, and control the autonomous driving of the vehicle by determining the static obstacle based on fusing first candidate sensor data, the first probability distribution, and the second probability distribution, wherein the first candidate sensor data corresponds to the first candidate virtual box.

The apparatus, wherein the processor is configured to obtain a second candidate virtual box based on an update age of the third sensor data being smaller than a first threshold value and at least one of a length of a virtual box obtained from the third sensor data or a width of the virtual box being smaller than a second threshold value, and control the autonomous driving of the vehicle by determining the dynamic obstacle based on fusing second candidate sensor data, the first probability distribution, and the second probability distribution, wherein the second candidate sensor data corresponds to the second candidate virtual box.

The apparatus, wherein the processor is configured to obtain, based on applying a weight to a probability value, a reliability value of each of the plurality of cells, wherein the probability value indicates at least one of the first sensor data being present in the probability distribution map or the second sensor data being present in the probability distribution map.

The apparatus, wherein the processor is configured to identify threshold cells among the plurality of cells, wherein each of the threshold cells has a first reliability value exceeding a third threshold value, and wherein the first reliability value indicates a level of confidence to classify objects within areas of each of the threshold cells, and classify at least one of points of the third sensor or a cluster of points as a road boundary with a second reliability value exceeding a threshold value, wherein the points of the third sensor are determined from the threshold cells, and wherein the cluster of points comprise the points of the third sensor.

The apparatus, wherein the processor is configured to obtain the first probability distribution by distributing the first sensor data to the probability distribution map in a radial shape.

The apparatus, wherein the processor is configured to obtain the second probability distribution by distributing the second sensor data to the probability distribution map in an arc shape.

The apparatus, wherein the processor is configured to generate, based on at least one of a polar coordinate system or a Cartesian coordinate system, the probability distribution map.

The apparatus, wherein the processor is configured to determine at least one of the static obstacle or the dynamic obstacle in real time by discretizing a probability distribution in which at least one of the first sensor data or the second sensor data is present.

The apparatus, wherein the processor is configured to generate the probability distribution map for identifying an external object within a designated distance from the vehicle.

According to the present disclosure, a method performed by an apparatus for controlling autonomous driving of a vehicle, the method may comprise generating a probability distribution map by dividing an area into a plurality of cells, wherein the area may comprise a designated angle in a designated direction from the vehicle, obtaining, based on the probability distribution map, a first probability distribution for first sensor data obtained by a first sensor and a second probability distribution for second sensor data obtained by a second sensor, and controlling the autonomous driving of the vehicle by determining, based on fusing the first probability distribution, the second probability distribution, and third sensor data obtained by a third sensor, at least one of a static obstacle or a dynamic obstacle.

The method may further comprise obtaining a first candidate virtual box based on an update age of the third sensor data being greater than or equal to a first threshold value and at least one of a length of a virtual box obtained from the third sensor data or a width of the virtual box being greater than or equal to a second threshold value, and controlling the autonomous driving of the vehicle by determining the static obstacle based on fusing first candidate sensor data, the first probability distribution, and the second probability distribution, wherein the first candidate sensor data corresponds to the first candidate virtual box.

The method may further comprise obtaining a second candidate virtual box based on an update age of the third sensor data being smaller than a first threshold value and at least one of a length of a virtual box obtained from the third sensor data or a width of the virtual box being smaller than a second threshold value, and controlling the autonomous driving of the vehicle by determining the dynamic obstacle based on fusing second candidate sensor data, the first probability distribution, and the second probability distribution, wherein the second candidate sensor data corresponds to the second candidate virtual box.

The method may further comprise obtaining, based on applying a weight to a probability value, a reliability value of each of the plurality of cells, wherein the probability value indicates at least one of the first sensor data being present in the probability distribution map or the second sensor data being present in the probability distribution map.

The method may further comprise identifying threshold cells among the plurality of cells, wherein each of the threshold cells has a first reliability value exceeding a third threshold value and wherein the first reliability value indicates a level of confidence to classify objects within areas of each of the threshold cells, and classifying at least one of points of the third sensor or a cluster of points as a road boundary with a second reliability value exceeding a threshold value, wherein the points of the third sensor are determined from the threshold cells, and wherein the cluster of points comprise the points of the third sensor.

The method may further comprise obtaining the first probability distribution by distributing the first sensor data to the probability distribution map in a radial shape.

The method may further comprise obtaining the second probability distribution by distributing the second sensor data to the probability distribution map in an arc shape.

The method may further comprise generating, based on at least one of a polar coordinate system or a Cartesian coordinate system, the probability distribution map.

The method may further comprise determining at least one of the static obstacle or the dynamic obstacle in real time by discretizing a probability distribution in which at least one of the first sensor data or the second sensor data is present.

The method may further comprise generating the probability distribution map for identifying an external object within a designated distance from the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram associated with a vehicle control apparatus, according to an example of the present disclosure;

FIG. 2 shows an example of a driving process of a vehicle, in an example of the present disclosure;

FIG. 3 shows an example of generating a probability distribution map, in an example of the present disclosure;

FIG. 4 shows an example of obtaining a probability distribution using sensor data obtained by a camera, in an example of the present disclosure;

FIG. 5 shows an example of obtaining a probability distribution using sensor data obtained by a RADAR, in an example of the present disclosure;

FIG. 6 shows an example of identifying a road boundary, in an example of the present disclosure;

FIG. 7 shows an example of a flowchart associated with a vehicle control method, according to an example of the present disclosure; and

FIG. 8 shows an example of a computing system associated with a vehicle control apparatus or vehicle control method, according to an example of the present disclosure.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted if they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

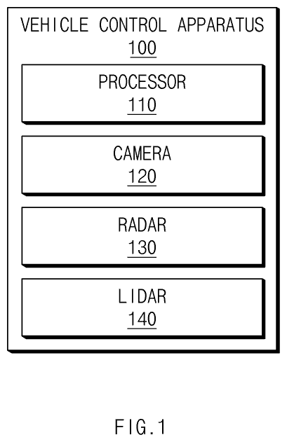

Hereinafter, examples of the present disclosure will be described in detail with reference to FIGS. 1 to 8.

FIG. 1 shows an example of a block diagram associated with a vehicle control apparatus, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection means. For example, the vehicle control apparatus 100 may further include components not shown in FIG. 1.

Referring to FIG. 1, a vehicle control apparatus 100 according to an example may include a processor 110, a camera 120, a RADAR 130, and a LiDAR 140. According to an example, the vehicle control apparatus 100 may further include a memory 150. The processor 110, the camera 120, the RADAR 130, the LiDAR 140, or the memory 150 may be electronically and/or operably coupled with each other by an electronical component including a communication bus.

Hereinafter, the fact that pieces of hardware are coupled operably may include the fact that a direct and/or indirect connection between the pieces of hardware is established by wired and/or wirelessly such that second hardware is controlled by first hardware among the pieces of hardware.

Although different blocks are shown, an example is not limited thereto. Some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. The hardware for processing data may include the processor 110.

For example, the hardware for processing data may include an arithmetic and logic unit (ALU), a floating point unit (FPU), a field programmable gate array (FPGA), a central processing unit (CPU), and/or an application processor (AP). The processor 110 may include a structure of a single-core processor, or may include a structure of a multi-core processor including a dual core, a quad core, a hexa core, or an octa core.

The camera 120 included in the vehicle control apparatus 100 according to an example may include one or more optical sensors (e.g., a charged coupled device (CCD) sensor or a complementary metal oxide semiconductor (CMOS) sensor) that generate electrical signals indicating the color and/or brightness of light. A plurality of optical sensors included in the camera 120 may be arranged in a form of a 2-dimensional array. The camera 120 may obtain electrical signals from a plurality of optical sensors substantially simultaneously and may generate images or frames, each of which corresponds to light reaching the optical sensors in two-dimensional grids and each of which includes a plurality of pixels arranged in two dimensions.

For example, photo data captured by using the camera 120 may refer to a plurality of images obtained from the camera 120. For example, video data captured by using the camera 120 may mean the sequence of a plurality of images obtained from the camera 120 at a designated frame rate.

For example, the camera 120 may obtain first sensor data. For example, the first sensor data may include at least one of photo data, or video data, or any combination thereof described above.

The RADAR 130 of the vehicle control apparatus 100 according to an example may detect reflected waves obtained as electromagnetic waves radiated from the RADAR 130 is reflected to an external object. For example, the RADAR 130 may identify at least one of a direction, a distance, or a speed, or any combination thereof of an external object with respect to the vehicle by detecting reflected waves.

For example, the RADAR 130 may obtain second sensor data. For example, the second sensor data may include a RADAR plot obtained by the RADAR 130.

The LiDAR 140 of the vehicle control apparatus 100 according to an example may obtain data sets obtained by identifying objects surrounding the vehicle control apparatus 100 (or a vehicle including the vehicle control apparatus 100). For example, the LiDAR 140 may identify at least one of a location of the surrounding object, a movement direction of the surrounding object, or the speed of the surrounding object, or any combination thereof based on a pulse laser signal emitted from the LiDAR 140 being reflected and returned by the surrounding object.

For example, the LiDAR 140 may obtain third sensor data. For example, the third sensor data may be obtained by the LiDAR 140 and may include a data set obtained by identifying objects surrounding the vehicle.

The memory 150 of the vehicle control apparatus 100 according to an example may include a hardware component for storing data and/or instructions that are to be input and/or output to the processor 110 of the vehicle control apparatus 100.

For example, the memory 150 may include a volatile memory including a random-access memory (RAM), or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof.

For example, the non-volatile memory includes at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof.

According to an example, the processor 110 of the vehicle control apparatus 100 may generate a probability distribution map by dividing an area including a designated angle of the designated direction from the vehicle into a plurality of cells. For example, the designated angle may include approximately 2 degrees.

For example, the processor 110 may generate a probability distribution map for identifying an external object within a designated distance from the vehicle. For example, the designated distance may include approximately 80 m.

For example, the processor 110 may generate the probability distribution map based on at least one of a polar coordinate system, or a Cartesian coordinate system, or any combination thereof. For example, the processor 110 may generate the probability distribution map by using at least one of a polar coordinate system or a Cartesian coordinate system.

In an example, the processor 110 may obtain a first probability distribution for the first sensor data obtained by the camera 120 by using the probability distribution map.

In an example, the processor 110 may obtain a second probability distribution for the second sensor data obtained by the RADAR 130 by using the probability distribution map.

In an example, the processor 110 may obtain the first probability distribution for the first sensor data and the second probability distribution for the second sensor data by using the probability distribution map.

For example, the processor 110 may obtain the first probability distribution by distributing the first sensor data to the probability distribution map in a radial method. For example, the radial method may involve a process where the first sensor data is distributed across a map or grid by calculating probabilities based on distance from a central point or using angular methods (such as working along lines radiating out from the center).

For example, the processor 110 may obtain the second probability distribution by distributing the second sensor data in an arc shape to the probability distribution map.

For example, the processor 110 may identify at least one of a static obstacle, or a dynamic obstacle, or any combination thereof in real time by discretizing the probability distribution in which at least one of the first sensor data, or the second sensor data, or any combination thereof is present. The processor 110 of the vehicle control apparatus 100 may control the operation of the vehicle in real time based on identifying at least one of a static obstacle, or a dynamic obstacle, or any combination thereof in real time.

For example, the processor 110 may control the operation of the vehicle such that the vehicle avoids at least one of a static obstacle (e.g., parked vehicles, roadside barriers, traffic cones, curbs, trees, or buildings, etc.), or a dynamic obstacle (e.g., moving vehicles, pedestrians, cyclists, animals, or objects like rolling debris, etc.), or any combination thereof based on identifying at least one of the static obstacle, or the dynamic obstacle, or any combination thereof.

In an example, the processor 110 may identify at least one of a static obstacle, or a dynamic obstacle, or any combination thereof based on fusing the first probability distribution, the second probability distribution, and the third sensor data obtained by the LiDAR 140. For example, the processor 110 may control the operation of the vehicle by identifying at least one of the static obstacle, or the dynamic obstacle, or any combination thereof based on fusing the first probability distribution, the second probability distribution, and the third sensor data.

For example, the processor 110 may obtain a first candidate virtual box in which an update age of the third sensor data is greater than or equal to a first threshold value, and at least one of a length of a virtual box obtained from the third sensor data, or a width of the virtual box, or any combination thereof is greater than or equal to a second threshold value. For example, a virtual box may include a contour box.

For example, the update age may include a period at which the third sensor data is updated.

For example, the processor 110 may identify the static obstacle based on fusing first candidate sensor data corresponding to the first candidate virtual box, the first probability distribution, and the second probability distribution. The processor 110 may control the operation of the vehicle by identifying a static obstacle based on fusing the first candidate sensor data corresponding to the first candidate virtual box, the first probability distribution, and the second probability distribution.

For example, the processor 110 may obtain a second candidate virtual box in which the update age of the third sensor data is smaller than the first threshold value, and at least one of the length of the virtual box obtained from the third sensor data, or the width of the virtual box, or any combination thereof is smaller than the second threshold value.

In particular, the processor 110 may obtain the second candidate virtual box in which the update age of the third sensor data is smaller than the first threshold value, and the length of the virtual box obtained from the third sensor data and the width of the virtual box is smaller than the second threshold value.

For example, the processor 110 may fuse second candidate sensor data corresponding to the second candidate virtual box, the first probability distribution, and the second probability distribution. For example, the processor 110 may control the operation of the vehicle by identifying a dynamic obstacle based on fusing the second candidate sensor data, the first probability distribution, and the second probability distribution.

For example, the processor 110 may apply a weight to a probability value indicating that at least one of the first sensor data, or the second sensor data, or any combination thereof is present in the probability distribution map.

For example, the processor 110 may obtain the reliability of each of the plurality of cells based on applying the weight to the probability value indicating that at least one of the first sensor data, or the second sensor data, or any combination thereof is present in the probability distribution map.

For example, the processor 110 may identify threshold cells, the reliability of each of which exceeds a third threshold value, from among the reliability of each of the plurality of cells. For example, the threshold cells may refer to areas or regions within a sensor's field (such as LiDAR) that meet or exceed a certain reliability value, which allows the processor to confidently classify objects or features in the environment. Examples of threshold cells may comprise grid cells where LiDAR sensors collect reliable point data indicating features like curbs or road lines, regions where consistent point clusters represent solid objects such as guardrails, and areas with high-confidence road features like painted lines or barriers that match predefined patterns. For example, the processor 110 may classify at least one of LiDAR points identified from the threshold cells, or a cluster of points (e.g., a point cloud) including the LiDAR points, or any combination thereof as a road boundary (e.g., curbs, painted road lines, guardrails, shoulders, medians, barriers, and natural boundaries such as ditches or trees that define the edges of the roadway, etc.) with high reliability.

For example, the processor 110 may control the operation of the vehicle based on classifying at least one of the LiDAR points identified from the threshold cells, or the point cloud including the LiDAR points, or any combination thereof as the road boundary with high reliability. As mentioned above, the vehicle control apparatus 100 according to an example may accurately detect at least one of a static obstacle, or a dynamic obstacle, or any combination thereof by fusing pieces of sensor data by using the probability distribution.

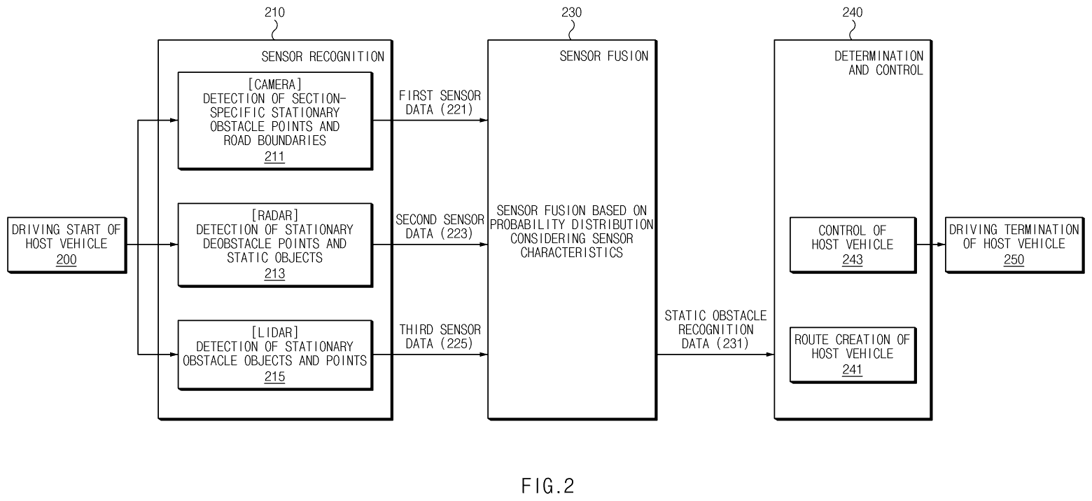

FIG. 2 shows an example of a driving process of a vehicle, in an example of the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Referring to FIG. 2, a processor (e.g., the processor 110 of FIG. 1) of a vehicle control apparatus (e.g., the vehicle control apparatus 100 of FIG. 1) according to an example may identify a driving start 200 of a vehicle. For example, the processor may perform sensor recognition 210 in response to the driving of the vehicle being started.

For example, the sensor recognition 210 may include at least one of detection of section-specific stationary obstacle points and road boundaries by a camera (211), detection of stationary obstacle points and static objects by a RADAR (213), or detection of stationary obstacle objects and points by a LiDAR (215), or any combination thereof. At least one of a stationary obstacle, a static object, or a stationary obstacle object, or any combination thereof, which is described above, may be included in the static obstacle described above in FIG. 1. For example, a stationary obstacle, static object, or stationary obstacle object may comprise parked cars, road signs, traffic barriers, pedestrian crosswalks (when empty), trees or poles, buildings or walls, debris, curbs, construction equipment, and stoplights or traffic lights, etc.

In an example, the processor may obtain first sensor data 221 based on the detection of section-specific stationary obstacle points and road boundaries by a camera (211).

In an example, the processor may obtain second sensor data 223 based on the detection of stationary obstacle points and static objects by the RADAR (213).

In an example, the processor may obtain third sensor data 225 based on the detection of stationary obstacle objects and points by the LiDAR (215).

In an example, the processor may perform sensor fusion 230 for fusing the first sensor data 221, the second sensor data 223, and the third sensor data 225 based on obtaining the first sensor data 221, the second sensor data 223, and the third sensor data 225.

For example, the processor may perform sensor fusion based on a probability distribution considering sensor characteristics.

Hereinafter, the sensor characteristics and corresponding actions will be briefly described.

For example, camera data may be expressed on a two-dimensional image plane, and thus the position estimation accuracy in a range direction may be very low. To overcome this, the processor may obtain a camera probability distribution by distributing camera point information obtained by recognizing a static obstacle in a radial method. For example, the camera probability distribution may include the first probability distribution described in FIG. 1.

For example, because RADAR data is obtained by measuring a distance using electromagnetic waves with weak straightness and long wavelength, the position recognition accuracy in an azimuth direction may be very low.

The azimuth direction may refer to the horizontal angle or orientation of an object relative to a vehicle, measured in degrees from a reference direction, for example, true north. In other words, it is the angle between the direction in which the vehicle is moving (or a fixed reference point) and the position of an object around the vehicle, measured along the horizontal plane. It is the left-right positioning of objects around the vehicle from the vehicle's perspective. For example, if an object is directly ahead of the vehicle, the azimuth angle is 0 degrees; if it's directly to the right, the azimuth angle is 90 degrees, and if it's directly behind, it would be 180 degrees.

Due to the limitations of RADAR (like weak straightness and long wavelength), the processor may struggle to precisely detect objects' positions in terms of this left-right orientation, which could affect the vehicle's ability to avoid or navigate around those objects.

To overcome this, the processor may obtain a RADAR probability distribution by distributing RADAR point information in an arc shape. For example, the RADAR probability distribution may include the second probability distribution described in FIG. 1.

For example, because LiDAR data is obtained by using the laser with strong straightness, a position estimation error of an object may be very low compared to other sensors. However, mis-recognition of static objects such as at least one of a static object fragmented from a dynamic object, a crosstalk phenomenon, or floor recognition, or any combination thereof may frequently occur. A crosstalk may occur due to signal reflections from the vehicle's own body or nearby surfaces (e.g., reflections from the road surface or vehicle parts, such as mirrors or bumpers), which causes false detection of points that are not real objects in the surrounding environment. Crosstalk may also result from interference between multiple sensors, where signals from another sensor's output are mistakenly detected as objects. Crosstalk may also arise from environmental factors such as rain, fog, or snow, where laser or sensor signals are scattered and cause spurious points to appear in the sensor data. Another example of crosstalk could be multipath reflections, where the signal bounces off multiple surfaces before returning to the sensor, creating ghost points that do not correspond to actual objects.

The floor recognition refers to the ability of the LiDAR sensor to correctly distinguish between the road surface (or ground) and other objects in the environment. LiDAR sensors emit laser beams to map the surroundings in 3D, including both static and dynamic objects. However, sometimes the sensor might misinterpret the flat surface of the road or ground (the “floor”) as an object, leading to incorrect data or false positives. For example, in autonomous driving, if the LiDAR incorrectly identifies the road surface as an obstacle, it may cause unnecessary reactions, such as braking or evasive maneuvers. This type of mis-recognition could lead to incorrect positioning of the vehicle relative to actual obstacles or impair decision-making in terms of navigation. In summary, floor recognition refers to the challenge of accurately identifying the road surface and avoiding its misinterpretation as an obstacle in a sensor (e.g., LiDAR) data.

Accordingly, to reflect characteristics indicating that there is no movement of a stationary obstacle including at least one of a road boundary, an underpass, or a tunnel wall, or any combination thereof, and the size of the stationary obstacle is large, the processor may filter only the stationary obstacle object, of which the update age is greater than or equal to a first threshold value and of which the length or width of a contour box is greater than or equal to a second threshold value, as a candidate of a final recognition output.

In an example, the processor may obtain static obstacle recognition data 231 based on the sensor fusion 230. For example, the processor may perform determination and control 240 by using the static obstacle recognition data 231. For example, the determination and control 240 may include determining whether an external object is at least one of a static obstacle, or a dynamic obstacle, or any combination thereof, creating a route for driving (e.g., autonomously or assisted) while a vehicle avoids the external object, and controlling an operation of the vehicle according to the created route.

In an example, the processor may perform route creation 241 of the vehicle based on obtaining the static obstacle recognition data 231.

In an example, the processor may perform vehicle control 243 based on the route creation 241 of the vehicle.

As mentioned above, the vehicle control apparatus according to an example may perform the route creation 241 of the vehicle by using the sensor fusion 230, thereby causing the safe operation of the vehicle by performing the vehicle control 243.

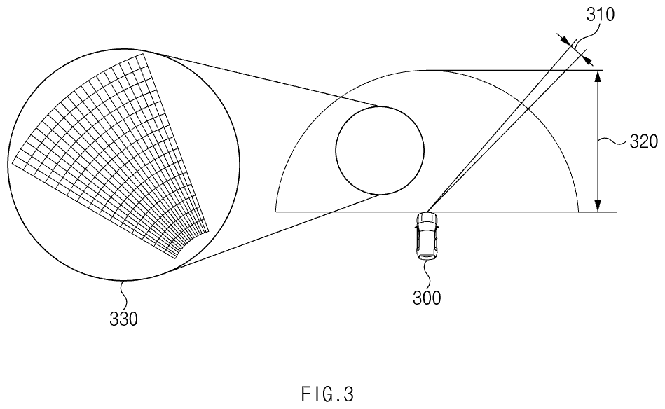

FIG. 3 shows an example of generating a probability distribution map, in an example of the present disclosure.

Referring to FIG. 3, a processor (e.g., the processor 110 of FIG. 1) of a vehicle control apparatus (e.g., the vehicle control apparatus 100 of FIG. 1) according to an example may be included in a vehicle 300 and may control of the operation of the vehicle 300.

In an example, the processor may generate a probability distribution map 330 for detecting an external object within a designated distance 320 from the vehicle 300. For example, the processor may generate the probability distribution map 330 by dividing an area including a designated angle 310 in a designated direction from the vehicle 300 into a plurality of cells. For example, the designated angle 310 may include approximately 180 degrees. If the designated angle 310 is approximately 180 degrees, the processor of the vehicle control apparatus may detect an external object located in front of the vehicle.

For example, the processor may generate the probability distribution map 330 discretized into an appropriate size to maintain the real-time property of an algorithm.

For example, the processor may generate a probability distribution map by dividing about 2 degrees into about 90 cells and dividing about 20 cm into about 400 cells.

The processor may generate the probability distribution map 330 divided into about 36,000 cells by dividing 180 degrees in front of the vehicle 300 and the distance of about 80 m in the same manner as described above.

As mentioned above, the processor may obtain a probability distribution, which is obtained by reflecting the probability distribution characteristics of a form capable of overcoming drawbacks of each sensor even at low resolution, by generating the probability distribution map 330 obtained by dividing the designated area into a plurality of cells based on the vehicle 300.

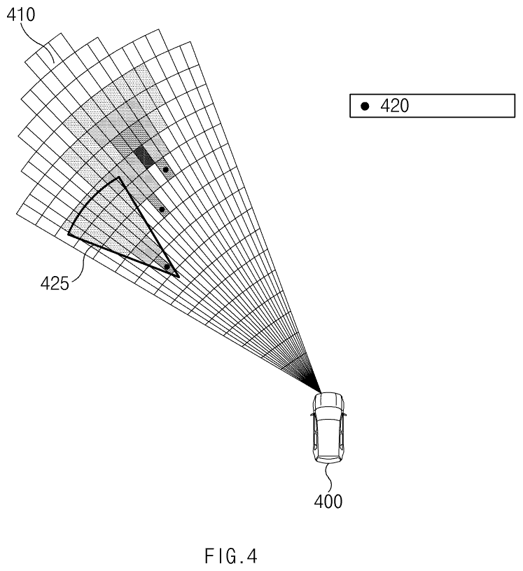

FIG. 4 shows an example of obtaining a probability distribution using sensor data obtained by a camera, in an example of the present disclosure.

Referring to FIG. 4, a processor (e.g., the processor 110 of FIG. 1) of a vehicle control apparatus (e.g., the vehicle control apparatus 100 of FIG. 1) according to an example may obtain first sensor data through a camera.

For example, the processor may obtain a first probability distribution by using the first sensor data obtained through the camera included in a vehicle 400.

For example, the first sensor data may include a point 420 obtained by identifying an external object within an image obtained by the camera.

For example, the processor may obtain the first sensor data including the point 420 obtained by identifying an external object within the image obtained by the camera.

In an example, the processor may express the point 420 in a probability distribution map 410.

For example, the processor may distribute the first sensor data including the point 420 to the probability distribution map 410 in a radial shape 425 based on expressing the point 420 in the probability distribution map 410.

The processor may obtain the first probability distribution for the first sensor data by distributing the first sensor data including the point 420 in the probability distribution map 410 in the radial shape 425.

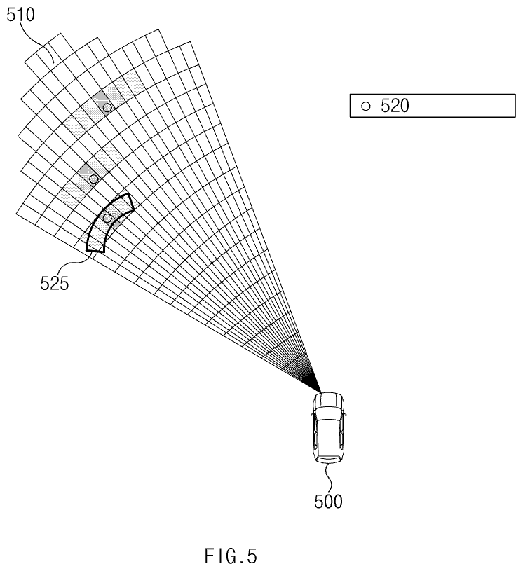

FIG. 5 shows an example of obtaining a probability distribution using sensor data obtained by a RADAR, in an example of the present disclosure.

Referring to FIG. 5, a processor (e.g., the processor 110 of FIG. 1) of a vehicle control apparatus (e.g., the vehicle control apparatus 100 of FIG. 1) according to an example may obtain second sensor data through a RADAR.

For example, the processor may obtain a second probability distribution by using the second sensor data obtained through a RADAR included in a vehicle 500.

For example, the second sensor data may include a point 520 obtained by identifying an external object within a RADAR plot obtained by the RADAR.

For example, the processor may obtain the second sensor data including the point 520 obtained by identifying an external object within a RADAR plot obtained by the RADAR.

In an example, the processor may express the point 520 in a probability distribution map 510.

For example, the processor may distribute the second sensor data including the point 520 to the probability distribution map 510 in an arc shape 525 based on expressing the point 520 in the probability distribution map 510.

The processor may obtain the second probability distribution for the second sensor data by distributing the second sensor data including the point 520 in the probability distribution map 510 in the arc shape 525.

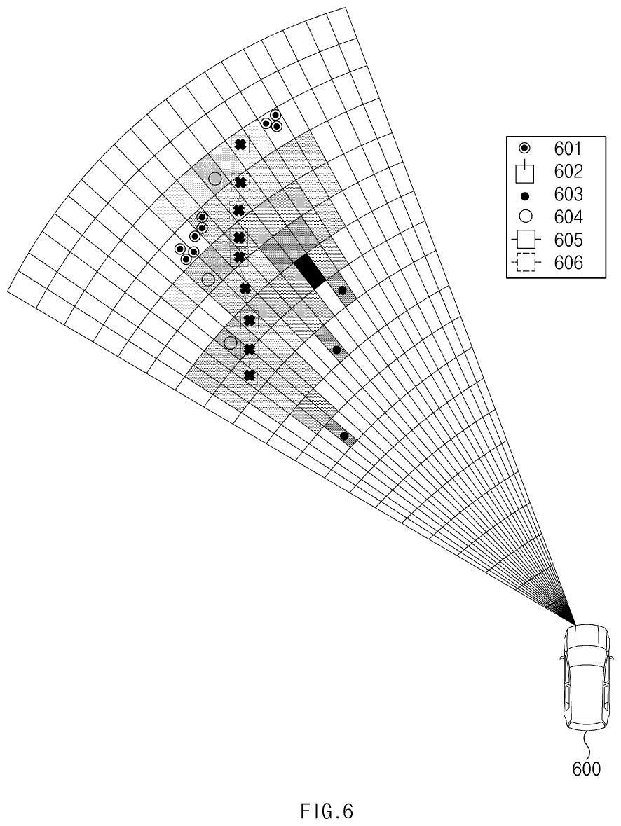

FIG. 6 shows an example of identifying a road boundary, in an example of the present disclosure.

Referring to FIG. 6, a processor (e.g., the processor 110 of FIG. 1) of a vehicle control apparatus (e.g., the vehicle control apparatus 100 of FIG. 1) according to an example may obtain at least one of a LiDAR point 601, a camera point 603, or a RADAR point 604, or any combination thereof.

For example, the LiDAR point 601 may include a contour point acquired by a LiDAR.

For example, the contour point may be obtained based on representative points, which are included in a point cloud, on each of layers formed based on a z-axis among an x-axis (e.g., parallel to a moving direction of a vehicle), a y-axis (e.g., perpendicular to the x-axis), and the z-axis (e.g., perpendicular to the y-axis).

For example, the representative points may include all or part of points, which are located at the outside, from among a plurality of points included in the point cloud. For example, the point cloud may be obtained by performing clustering based on each of the plurality of points obtained by the LiDAR being identified within a specific distance.

For example, the processor may obtain a virtual box 602 corresponding to an external object by the LiDAR point 601. Although not separately shown in FIG. 6, the processor may control the operation of a vehicle 600 based on at least one of a heading direction of the virtual box 602 corresponding to the external object, a size of the virtual box 602, a movement direction of the virtual box 602, or a speed of the virtual box 602, or any combination thereof.

For example, the camera point 603 may include a point where the external object is identified within an image obtained by a camera. For example, the camera point 603 may be referred to as “camera free space”.

For example, the RADAR point 604 may include a point where the external object is identified within a RADAR plot obtained by a RADAR. For example, the RADAR point 604 may be referred to as “RADAR free space”.

In an example, the processor may identify a first road boundary 605 with first reliability.

In an example, the processor may identify a second road boundary 606 with second reliability.

For example, the first reliability may include reliability higher than the second reliability. For example, the second reliability may include reliability lower than the first reliability.

In an example, the processor may control the operation of the vehicle 600 based on at least one of the first road boundary 605 with the first reliability, or the second road boundary 606 with the second reliability, or any combination thereof.

As mentioned above, the processor of the vehicle control apparatus according to an example may control the operation of the vehicle 600 to avoid a road boundary by classifying (or identifying) the road boundary depending on reliability.

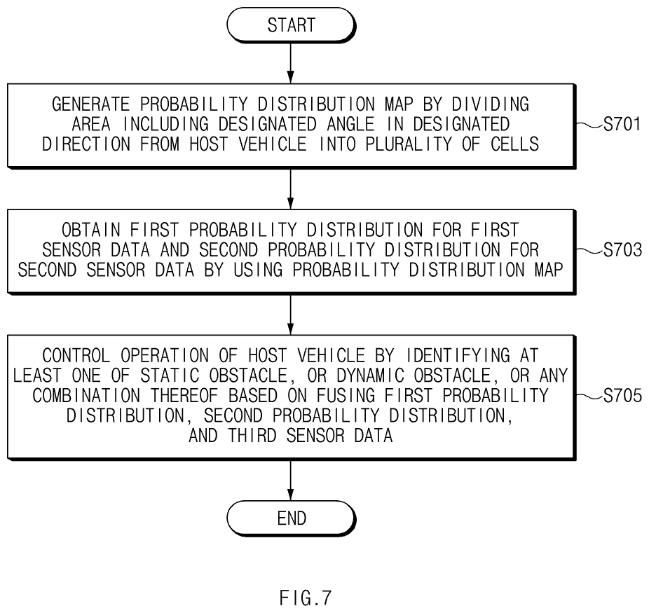

FIG. 7 shows an example of a flowchart associated with a vehicle control method, according to an example of the present disclosure.

Hereinafter, it is assumed that the vehicle control apparatus 100 of FIG. 1 performs the process of FIG. 7. In addition, in a description of FIG. 7, it may be understood that an operation described as being performed by an apparatus is controlled by the processor 110 of the vehicle control apparatus 100. One, some, or all steps of the process of FIG. 7, or portions thereof, may be performed by one or more other circuits. One or some, steps of the process of FIG. 7 may be omitted, performed in other orders, and/or otherwise modified, and/or one or more additional steps may be added.

At least one of operations of FIG. 7 may be performed by the vehicle control apparatus 100 of FIG. 1. At least one of operations of FIG. 7 may be performed by the processor 110 of FIG. 1. Each of the operations in FIG. 7 may be performed sequentially, but is not necessarily sequentially performed. For example, the order of operations may be changed, and at least two operations may be performed in parallel.

Referring to FIG. 7, in S701, a vehicle control method according to an example may include an operation of generating a probability distribution map by dividing an area including a designated angle in the designated direction from the vehicle into a plurality of cells.

For example, the vehicle control method may include an operation of generating the probability distribution map based on at least one of a polar coordinate system, or a Cartesian coordinate system, or any combination thereof.

In S703, the vehicle control method according to an example may include an operation of obtaining the first probability distribution for the first sensor data and the second probability distribution for the second sensor data by using the probability distribution map.

For example, the vehicle control method may include an operation of obtaining first sensor data through a camera.

For example, the vehicle control method may include an operation of obtaining second sensor data through a RADAR.

For example, the vehicle control method may include an operation of obtaining third sensor data through a LiDAR.

For example, the vehicle control method may include an operation of obtaining the first probability distribution by distributing the first sensor data to the probability distribution map in a radial shape.

For example, the vehicle control method may include an operation of obtaining the second probability distribution by distributing the second sensor data to the probability distribution map in an arc shape.

For example, the vehicle control method may include an operation of generating the probability distribution map for identifying an external object within a designated distance from the vehicle.

In S705, the vehicle control method according to an example may include an operation of controlling the operation of the vehicle by identifying at least one of the static obstacle, or the dynamic obstacle, or any combination thereof based on fusing the first probability distribution, the second probability distribution, and the third sensor data.

For example, the vehicle control method may include an operation of identifying at least one of the static obstacle, or the dynamic obstacle, or any combination thereof in real time by discretizing a probability distribution in which at least one of the first sensor data, or the second sensor data, or any combination thereof is present.

For example, the vehicle control method may include an operation of obtaining a first candidate virtual box in which an update age of the third sensor data is greater than or equal to a first threshold value, and at least one of a length of a virtual box obtained from the third sensor data, or a width of the virtual box, or any combination thereof is greater than or equal to a second threshold value.

For example, the vehicle control method may include an operation of fusing the first candidate sensor data corresponding to the first candidate virtual box, the first probability distribution, and the second probability distribution.

For example, the vehicle control method may include an operation of controlling the operation of the vehicle by identifying a static obstacle based on fusing the first candidate sensor data corresponding to the first candidate virtual box, the first probability distribution, and the second probability distribution.

For example, the vehicle control method may include an operation of obtaining a second candidate virtual box in which the update age of the third sensor data is smaller than the first threshold value, and at least one of the length of the virtual box obtained from the third sensor data, or the width of the virtual box, or any combination thereof is smaller than the second threshold value.

For example, the vehicle control method may include an operation of obtaining the second candidate virtual box in which the update age of the third sensor data is smaller than the first threshold value, and the length of the virtual box obtained from the third sensor data and the width of the virtual box is smaller than the second threshold value.

For example, the vehicle control method may include an operation of controlling the operation of the vehicle by identifying the dynamic obstacle based on fusing second candidate sensor data corresponding to the second candidate virtual box, the first probability distribution, and the second probability distribution.

For example, the vehicle control method may include an operation of obtaining reliability of each of the plurality of cells based on applying a weight to a probability value indicating that at least one of the first sensor data, or the second sensor data, or any combination thereof is present in the probability distribution map.

For example, the vehicle control method may include an operation of identifying threshold cells, the reliability of each of which exceeds a third threshold value, from among the reliability of each of the plurality of cells.

For example, the vehicle control method may include an operation of classifying at least one of LiDAR points identified from the threshold cells, or a point cloud including the LiDAR points, or any combination thereof as a road boundary with high reliability.

For example, the vehicle control method may include an operation of classifying at least one of LiDAR points identified from the threshold cells, or a point cloud including the LiDAR points, or any combination thereof as a first road boundary with first high reliability.

For example, the vehicle control method may include an operation of identifying candidate threshold cells, the reliability of each of which is smaller than or equal to a third threshold value and exceeds a fourth threshold value, from among cells different from the threshold cells. For example, the candidate threshold cells may refer to cells or regions in the environment detected by sensors (like LiDAR) that have a level of reliability that falls within a specific range. Specifically, the reliability of these cells is less than or equal to third threshold value but still greater than fourth threshold value. The candidate threshold cells may be cells where the sensor data is moderately reliable, but not as reliable as the threshold cells. The candidate threshold cells may be those cells with intermediate reliability that may still provide useful data for controlling a vehicle, even though they are less reliable than threshold cells.

In summary, the candidate threshold cells may represent areas where the sensor data is moderately reliable, neither fully trustworthy nor completely unreliable. These cells may be useful for vehicle control in situations where there is no enough data to definitively classify objects as road boundaries or obstacles but still provide valuable information. A vehicle control system may consider these candidate cells when making driving decisions, especially in uncertain or ambiguous environments, such as poorly marked roads, dim lighting, or partial obstructions.

For example, the vehicle control method may include an operation of classifying at least one of LiDAR points identified from the candidate threshold cells, or a point cloud including the LiDAR points, or any combination thereof as a road boundary with low reliability.

For example, the vehicle control method may include an operation of classifying at least one of LiDAR points identified from the candidate threshold cells, or a point cloud including the LiDAR points, or any combination thereof as a second road boundary with second high reliability.

For example, the vehicle control method may include an operation of controlling the operation of the vehicle based on at least one of a first road boundary, or a second road boundary, or any combination thereof.

As described above, the vehicle control method according to an example may include an operation of obtaining a probability distribution map and/or probability distribution to fuse the first sensor data obtained by the camera, the second sensor data obtained by the RADAR, and the third sensor data obtained by the LiDAR. The vehicle control method may relatively accurately identify at least one of a static obstacle, or a dynamic obstacle, or any combination thereof by fusing the first sensor data, the second sensor data, and the third sensor data by using the probability distribution.

The vehicle control method may control the operation of the vehicle by fusing the first sensor data, the second sensor data, and the third sensor data by using the probability distribution and by relatively accurately identifying at least one of a static obstacle, or a dynamic obstacle, or any combination thereof, thereby preventing accidents.

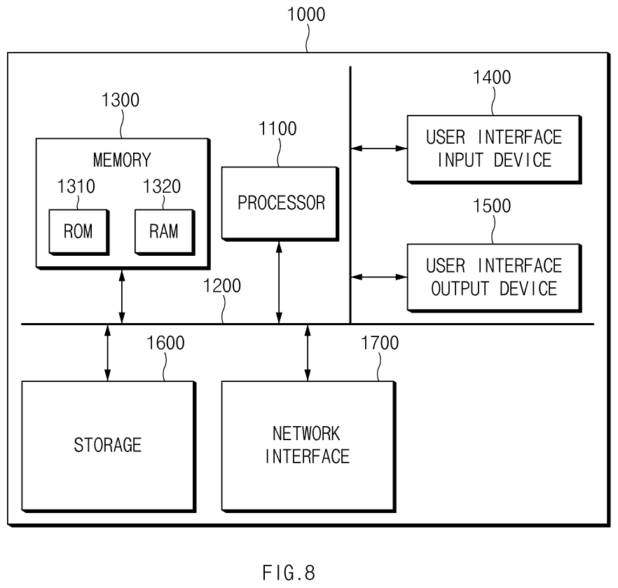

FIG. 8 shows an example of a computing system associated with a vehicle control apparatus or vehicle control method, according to an example of the present disclosure.

Referring to FIG. 8, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the examples of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

The present disclosure was made to solve the above-mentioned problems occurring in the prior art while advantages achieved by the prior art are maintained intact.

An example of the present disclosure provides a vehicle control apparatus for detecting an external object with high reliability by fusing pieces of sensor data based on a probability distribution, and a method thereof.

An example of the present disclosure provides a vehicle control apparatus for accurately identifying a static obstacle by fusing pieces of sensor data based on the probability distribution, and a method thereof.

An example of the present disclosure provides a vehicle control apparatus for accurately detecting an external object even if a vehicle is driving at night by fusing pieces of sensor data based on the probability distribution, and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a camera that obtains first sensor data, a radio detection and ranging (RADAR) that obtains second sensor data, a light detection and ranging (LiDAR) that obtains third sensor data, and a processor. The processor may generate a probability distribution map by dividing an area including a designated angle in a designated direction from a vehicle into a plurality of cells, may obtain a first probability distribution for the first sensor data and a second probability distribution for the second sensor data by using the probability distribution map, and may control an operation of the vehicle by identifying at least one of a static obstacle, or a dynamic obstacle, or any combination thereof based on fusing the first probability distribution, the second probability distribution, and the third sensor data.

In an example, the processor may obtain a first candidate virtual box in which an update age of the third sensor data is greater than or equal to a first threshold value, and at least one of a length of a virtual box obtained from the third sensor data, or a width of the virtual box, or any combination thereof is greater than or equal to a second threshold value, and may control the operation of the vehicle by identifying the static obstacle based on fusing first candidate sensor data corresponding to the first candidate virtual box, the first probability distribution, and the second probability distribution.

In an example, the processor may obtain a second candidate virtual box in which an update age of the third sensor data is smaller than a first threshold value, and at least one of a length of a virtual box obtained from the third sensor data, or a width of the virtual box, or any combination thereof is smaller than a second threshold value, and may control the operation of the vehicle by identifying the dynamic obstacle based on fusing second candidate sensor data corresponding to the second candidate virtual box, the first probability distribution, and the second probability distribution.

In an example, the processor may obtain reliability of each of the plurality of cells based on applying a weight to a probability value indicating that at least one of the first sensor data, or the second sensor data, or any combination thereof is present in the probability distribution map.

In an example, the processor may identify threshold cells, reliability of each of which exceeds a third threshold value, from among the reliability of each of the plurality of cells, and may classify at least one of LiDAR points identified from the threshold cells, or a point cloud including the LiDAR points, or any combination thereof as a road boundary with high reliability.

In an example, the processor may obtain the first probability distribution by distributing the first sensor data to the probability distribution map in a radial shape.

In an example, the processor may obtain the second probability distribution by distributing the second sensor data to the probability distribution map in an arc shape.

In an example, the processor may generate the probability distribution map based on at least one of a polar coordinate system, or a Cartesian coordinate system, or any combination thereof.

In an example, the processor may identify at least one of the static obstacle, or the dynamic obstacle, or any combination thereof in real time by discretizing a probability distribution in which at least one of the first sensor data, or the second sensor data, or any combination thereof is present.

In an example, the processor may generate the probability distribution map for identifying an external object within a designated distance from the vehicle.

According to an example of the present disclosure, a vehicle control method may include generating, by a processor, a probability distribution map by dividing an area including a designated angle in a designated direction from a vehicle into a plurality of cells, obtaining a first probability distribution for first sensor data obtained by a camera, and a second probability distribution for second sensor data obtained by a RADAR by using the probability distribution map, and controlling an operation of the vehicle by identifying at least one of a static obstacle, or a dynamic obstacle, or any combination thereof based on fusing the first probability distribution, the second probability distribution, and third sensor data obtained by a LiDAR.

According to an example, the vehicle control method may include obtaining a first candidate virtual box in which an update age of the third sensor data is greater than or equal to a first threshold value, and at least one of a length of a virtual box obtained from the third sensor data, or a width of the virtual box, or any combination thereof is greater than or equal to a second threshold value, and controlling the operation of the vehicle by identifying the static obstacle based on fusing first candidate sensor data corresponding to the first candidate virtual box, the first probability distribution, and the second probability distribution.

According to an example, the vehicle control method may include obtaining a second candidate virtual box in which an update age of the third sensor data is smaller than a first threshold value, and at least one of a length of a virtual box obtained from the third sensor data, or a width of the virtual box, or any combination thereof is smaller than a second threshold value, and controlling the operation of the vehicle by identifying the dynamic obstacle based on fusing second candidate sensor data corresponding to the second candidate virtual box, the first probability distribution, and the second probability distribution.

According to an example, the vehicle control method may include obtaining reliability of each of the plurality of cells based on applying a weight to a probability value indicating that at least one of the first sensor data, or the second sensor data, or any combination thereof is present in the probability distribution map.

According to an example, the vehicle control method may include identifying threshold cells, reliability of each of which exceeds a third threshold value, from among the reliability of each of the plurality of cells, and classifying at least one of LiDAR points identified from the threshold cells, or a point cloud including the LiDAR points, or any combination thereof as a road boundary with high reliability.

According to an example, the vehicle control method may include obtaining the first probability distribution by distributing the first sensor data to the probability distribution map in a radial shape.

According to an example, the vehicle control method may include obtaining the second probability distribution by distributing the second sensor data to the probability distribution map in an arc shape.

According to an example, the vehicle control method may include generating the probability distribution map based on at least one of a polar coordinate system, or a Cartesian coordinate system, or any combination thereof.

According to an example, the vehicle control method may include identifying at least one of the static obstacle, or the dynamic obstacle, or any combination thereof in real time by discretizing a probability distribution in which at least one of the first sensor data, or the second sensor data, or any combination thereof is present.

According to an example, the vehicle control method may include generating the probability distribution map for identifying an external object within a designated distance from the vehicle.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, the examples of the present disclosure are provided to explain the spirit and scope of the present disclosure, but not to limit them, so that the spirit and scope of the present disclosure is not limited by the examples. The scope of the present disclosure should be construed on the basis of the accompanying claims, and all the technical ideas within the scope equivalent to the claims should be included in the scope of the present disclosure.

The above description is merely an example of the technical idea of the present disclosure, and various modifications and modifications may be made by one skilled in the art without departing from the essential characteristic of the present disclosure.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

The present technology may detect an external object with high reliability by fusing pieces of sensor data based on a probability distribution.

Moreover, the present technology may accurately identify a static obstacle by fusing pieces of sensor data based on the probability distribution.

Furthermore, the present technology may accurately detect an external object even if a vehicle is driving at night by fusing pieces of sensor data based on the probability distribution.

Besides, a variety of effects directly or indirectly understood through the present disclosure may be provided.

Hereinabove, although the present disclosure was described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling autonomous driving of a vehicle, the apparatus comprising:
a first sensor configured to obtain first sensor data;
a second sensor configured to obtain second sensor data;
a third sensor configured to obtain third sensor data; and
a processor configured to:
generate a probability distribution map by dividing an area into a plurality of cells, wherein the area comprises a designated angle in a designated direction from the vehicle;
obtain, based on the probability distribution map, a first probability distribution for the first sensor data and a second probability distribution for the second sensor data; and
control the autonomous driving of the vehicle by determining, based on fusing the first probability distribution, the second probability distribution, and the third sensor data, at least one of a static obstacle or a dynamic obstacle.

2. The apparatus of claim 1, wherein the processor is configured to:
obtain a first candidate virtual box based on an update age of the third sensor data being greater than or equal to a first threshold value and at least one of a length of a virtual box obtained from the third sensor data or a width of the virtual box being greater than or equal to a second threshold value; and
control the autonomous driving of the vehicle by determining the static obstacle based on fusing first candidate sensor data, the first probability distribution, and the second probability distribution, wherein the first candidate sensor data corresponds to the first candidate virtual box.

3. The apparatus of claim 1, wherein the processor is configured to:
obtain a second candidate virtual box based on an update age of the third sensor data being smaller than a first threshold value and at least one of a length of a virtual box obtained from the third sensor data or a width of the virtual box being smaller than a second threshold value; and
control the autonomous driving of the vehicle by determining the dynamic obstacle based on fusing second candidate sensor data, the first probability distribution, and the second probability distribution, wherein the second candidate sensor data corresponds to the second candidate virtual box.

4. The apparatus of claim 1, wherein the processor is configured to:
obtain, based on applying a weight to a probability value, a reliability value of each of the plurality of cells, wherein the probability value indicates at least one of the first sensor data being present in the probability distribution map or the second sensor data being present in the probability distribution map.

5. The apparatus of claim 4, wherein the processor is configured to:
identify threshold cells among the plurality of cells, wherein each of the threshold cells has a first reliability value exceeding a third threshold value, and wherein the first reliability value indicates a level of confidence to classify objects within areas of each of the threshold cells; and
classify at least one of points of the third sensor or a cluster of points as a road boundary with a second reliability value exceeding a threshold value, wherein the points of the third sensor are determined from the threshold cells, and wherein the cluster of points comprise the points of the third sensor.

6. The apparatus of claim 1, wherein the processor is configured to:
obtain the first probability distribution by distributing the first sensor data to the probability distribution map in a radial shape.

7. The apparatus of claim 1, wherein the processor is configured to:
obtain the second probability distribution by distributing the second sensor data to the probability distribution map in an arc shape.

8. The apparatus of claim 1, wherein the processor is configured to:
generate, based on at least one of a polar coordinate system or a Cartesian coordinate system, the probability distribution map.

9. The apparatus of claim 1, wherein the processor is configured to:
determine at least one of the static obstacle or the dynamic obstacle in real time by discretizing a probability distribution in which at least one of the first sensor data or the second sensor data is present.

10. The apparatus of claim 1, wherein the processor is configured to:
generate the probability distribution map for identifying an external object within a designated distance from the vehicle.

11. A method performed by an apparatus for controlling autonomous driving of a vehicle, the method comprising:
generating a probability distribution map by dividing an area into a plurality of cells, wherein the area comprises a designated angle in a designated direction from the vehicle;
obtaining, based on the probability distribution map, a first probability distribution for first sensor data obtained by a first sensor and a second probability distribution for second sensor data obtained by a second sensor; and
controlling the autonomous driving of the vehicle by determining, based on fusing the first probability distribution, the second probability distribution, and third sensor data obtained by a third sensor, at least one of a static obstacle or a dynamic obstacle.

12. The method of claim 11, further comprising:
obtaining a first candidate virtual box based on an update age of the third sensor data being greater than or equal to a first threshold value and at least one of a length of a virtual box obtained from the third sensor data or a width of the virtual box being greater than or equal to a second threshold value; and
controlling the autonomous driving of the vehicle by determining the static obstacle based on fusing first candidate sensor data, the first probability distribution, and the second probability distribution, wherein the first candidate sensor data corresponds to the first candidate virtual box.

13. The method of claim 11, further comprising:
obtaining a second candidate virtual box based on an update age of the third sensor data being smaller than a first threshold value and at least one of a length of a virtual box obtained from the third sensor data or a width of the virtual box being smaller than a second threshold value; and
controlling the autonomous driving of the vehicle by determining the dynamic obstacle based on fusing second candidate sensor data, the first probability distribution, and the second probability distribution, wherein the second candidate sensor data corresponds to the second candidate virtual box.

14. The method of claim 11, further comprising:
obtaining, based on applying a weight to a probability value, a reliability value of each of the plurality of cells, wherein the probability value indicates at least one of the first sensor data being present in the probability distribution map or the second sensor data being present in the probability distribution map.

15. The method of claim 14, further comprising:
identifying threshold cells among the plurality of cells, wherein each of the threshold cells has a first reliability value exceeding a third threshold value and wherein the first reliability value indicates a level of confidence to classify objects within areas of each of the threshold cells; and
classifying at least one of points of the third sensor or a cluster of points as a road boundary with a second reliability value exceeding a threshold value, wherein the points of the third sensor are determined from the threshold cells, and wherein the cluster of points comprise the points of the third sensor.

16. The method of claim 11, further comprising:
obtaining the first probability distribution by distributing the first sensor data to the probability distribution map in a radial shape.

17. The method of claim 11, further comprising:
obtaining the second probability distribution by distributing the second sensor data to the probability distribution map in an arc shape.

18. The method of claim 11, further comprising:
generating, based on at least one of a polar coordinate system or a Cartesian coordinate system, the probability distribution map.

19. The method of claim 11, further comprising:
determining at least one of the static obstacle or the dynamic obstacle in real time by discretizing a probability distribution in which at least one of the first sensor data or the second sensor data is present.

20. The method of claim 11, further comprising:
generating the probability distribution map for identifying an external object within a designated distance from the vehicle.
